(19) United States
(12) Patent Application Publication
(10) Pub. No.: US 2018/0230239 A1
(43) Pub. Date: Aug. 16, 2018

(54) A STARCH-BASED FOOD THICKENER WITH LOW MOLECULAR WEIGHT AND A PREPARATION METHOD THEREOF

(71) Applicant: SOUTH CHINA UNIVERSITY OF TECHNOLOGY, Guangzhou City (CN)

(72) Inventors: Ling CHEN, Guangzhou City (CN); Pingping BIE, Guangzhou City (CN); Huayin PU, Guangzhou City (CN); Xiaoxi LI, Guangzhou City (CN); Binjia ZHANG, Guangzhou City (CN)

(73) Assignee: SOUTH CHINA UNIVERSITY OF TECHNOLOGY, Guangzhou City (CN)

(21) Appl. No.: 15/750,512

(22) PCT Filed: Dec. 24, 2015
(86) PCT No.: PCT/CN2015/098609

§ 371 Date: Feb. 6, 2018

(30) Foreign Application Priority Data
Aug. 6, 2015 (CN) 201510477691.9

(51) Int. Cl. C08B 30/12; A23L 5/30; A23L 29/212

(52) U.S. Cl. CPC C08B 30/12; A23V 2002/00; A23L 29/212; A23L 5/30

(57) ABSTRACT

A starch-based food thickener with low molecular weight and a preparation method thereof, comprising the steps of: adding starch powders with 5%-30% moisture content into an atmospheric pressure low-temperature dielectric barrier discharge plasma reactor, regulating the discharge gap to 0.2 mm-0.8 mm at atmospheric pressure, the discharge input voltage to 30 V-70 V, and the discharge current to 0.2 A-2.4 A, subjecting the materials in a fluidized state to plasma action in the circulating system by regulating the air flow rate with controlling time longer than 0.5 min, and then taking out the product after the completion of the reaction, i.e., to obtain a starch-based food thickener with low molecular weight. The method has such advantages as a simple technique involved, low cost, recyclable processing, large processing capacity, superior reaction uniformity, etc., and is also capable of efficiently and quickly degrading the molecular weight of starch, e.g., by 1-3 order(s) of magnitude within a short time. Moreover, the product has a superior transparency, retrogradation stability, and a certain thickening effect.

### TECHNICAL FIELD

The present invention relates to a method for preparing a food thickener, and particularly to a method for preparing a starch-based food thickener with low molecular weight by using an atmospheric pressure low-temperature plasma in conjunction with fluidization modification technique.

### BACKGROUND

A food thickener refers to a hydrophilic food additive which is soluble or dispersible in water, able to increase the viscosity of the fluid or semi-fluid food, and capable of maintaining the relative stability of the system. A thickener can increase the viscosity of a food or help same form a gel, thereby modifying the physical properties of the food, and giving the food a sticky, smooth and appropriate taste, and also has the effect of emulsifying, stabilizing or suspending the food. Common food thickeners include starch, gelatin, sodium alginate, casein, guar gum, chitosan, acacia, xanthan gum, soy protein, agar and the like. At present, starchy food thickeners are mainly pre-gelatinized starch, acid-modified starch, oxidized starch, esterified starch, hydroxyalkyl starch and cross-linked starch. Different starch-based food thickeners vary greatly in properties, wherein the main properties include the capabilities of improving the resistance to high temperature and shearing of starch, as well as those of improving pH stability, adhesion, transparency, film forming, gel strength, emulsification and the like. An appropriate modified starch is generally selected in a targeted manner according to the application requirements.

The molecular weight of starch is of great significance to the application of thickeners. In theory, at present, the commonly used starchy thickener can be prepared through the starch modification of either increasing or decreasing the molecular weight of starch, but both of the above two have their corresponding application space. It is generally believed that a thickener with high molecular weight mainly reflects its thickening and bonding effects, while a thickener with low molecular weight mainly reflects its stability, gelation and film forming property. In addition, the thickener with low molecular weight also has such characteristics as high solid concentration with low viscosity, energy saving, rapid drying and easiness for transportation, and as a result, it is widely used in starch products, dressing, sauces, fillings, dairy products and flavor products. At present, the preparation methods of the starch-based thickener with low molecular weight are as follows: (1) thermal degradation method: placing the starch in a high temperature reactor, and depolymerizing the starch molecules by means of thermal effect to reduce the molecular weight of the starch; (2) acid hydrolysis method: treating the starch with acid below the gelatinization temperature, to reduce its molecular weight through the acid hydrolysis of the starch; (3) enzymatic degradation method: selecting appropriate type and addition amount of amylase, to reduce its molecular weight through enzymatic degradation of the starch molecular chain; and (4) chemical modification method, such as oxidative degradation. At present, the starchy thickeners with low molecular weight are mainly the dextrin, acid-modified starch, oxidized starch and the like. These starches either involve hidden danger and problems concerning food safety, e.g., residual chemical reagents, or need a longer synthesis time and high energy consumption.

With the advances in science and technology, the plasma modification technique attracts much attention as it makes a gas-phase dry chemical reaction possible through the absorption of electricity, which has the characteristics of water saving, energy saving, being clean and safety in production. At present, the most mature plasma modification technique is the dielectric barrier discharge under atmospheric pressure. M A Pibo et al. (M A Pibo, X U Weilin, F A N Dongcui, and C A O Genyang, Study on Effect of Plasma Treatment on Starch Properties, Journal of Wuhan University of Science and Engineering, 2008, 21 (6), 38-42) treated the starch with the dielectric barrier discharge plasma, indicating that carboxyl groups were introduced into the starch molecules, and the hydrophilicity increased after the treatment, but the internal destructive effect was not obvious. The starch textile pulp adhesion, the serous membrane rupture strength, the serous membrane rupture elongation and the serous membrane moisture absorption can be changed through treatment with the dielectric barrier discharge plasma. However, for the powder, there are small processing size, nonuniform surface treatment and the like in the treatment with plasma due to the agglomeration between the particles, which further induce problems such as heterogeneous reaction, unstable performance of the reaction products, and poor controllability during the powder modification through the current dielectric barrier discharge plasma technique.

Fluidization makes the solid particles suspended with the aid of flowing fluid, so that the solid particles have some apparent characteristics of fluid, which is an engineering technique to enhance the contact and transfer between solid particles and fluids. Due to the strong circulation of fluidized solid particles, there is a good interaction and high mass transfer efficiency between the particles and fluids. At present, there have been some reports, both at home and abroad, suggesting the application of fluidization technique in the modification of starch powder. L I U Junhai et al. (L I U Junhai and L I Zhizhou, Study on Fluidization Preparation and Granulation of Cationic Starch, China Pulp & Paper, 2007, 02, 23-26) prepared a cationic starch using the fluidization technique, and the effects of the air mass flow in the fluidized bed on the height of bed, pressure drop, degree of substitution and the reaction efficiency were studied. Thomas J. E., et al. (Thomas J. E., Kamlesh S., James J. K., Christopher C. L., and Tushar S., Thermally Inhibited Polysaccharides and Process of Preparing, 2014, U.S. Pat. No. 8,759,511) treated the starch by heating with a fluidized bed, reacting same at a higher temperature for a certain period of time to generate a cross-linked starch, and the effects of gas oxygen content, treatment temperature and time on starch performance were investigated. In the process of preparing modified starch, it is very difficult to react at room temperature. In order to achieve the corresponding effects, the reaction must be carried out at a high temperature. During fluidization reaction at the high temperature, the starch particles collide with each other and many small particles are formed, which put forward higher requirements for the subsequent separation equipment and also reduces the yield. Therefore, there are many shortcomings when the fluidization reaction is directly applied in starch modification.

### SUMMARY

With regard to the above shortcomings existing in the prior art, the technical problem to be solved by the present invention is to provide a method for preparing a starch-based food thickener with low molecular weight by using an atmospheric pressure low-temperature dielectric barrier discharge plasma in conjunction with fluidization technique. The starch molecules are modified by the atmospheric pressure low-temperature dielectric barrier discharge plasma in conjunction with fluidization reaction technique, in order to overcome the shortcoming of the original starch in thickening performance and also avoid the use of toxic chemical reagents, so as to obtain a dry method for preparing a non-toxic, less polluted and convenient starch-based food thickener with low molecular weight as well as a food thickener produced thereby.

In order to achieve the object, the present invention adopts a technical solution as follows:

A preparation method of a starch-based food thickener with low molecular weight, comprising the steps of:

adding starch powders with 5%-30% moisture content into an atmospheric pressure low-temperature dielectric barrier discharge plasma reactor, regulating the discharge gap to 0.2 mm-0.8 mm at atmospheric pressure, the discharge input voltage to 30 V-70 V, and the discharge current to 0.2 A-2.4 A, subjecting the materials in a fluidized state to plasma action in the circulating system by regulating the air flow rate with controlling time longer than 0.5 min, and then taking out the product after the completion of the reaction, i.e., to obtain a starch-based food thickener with low molecular weight.

Preferably, the time is controlled between 0.5 min-30 min.

The method is not limited by the source of starch and can use starches of different sources as a raw material, and the starch may be one of or a mixture comprising two or more of a corn starch, a tapioca starch, a potato starch, a high amylose corn starch, an indica rice starch, a japonica starch, a sweet potato starch, a waxy corn starch and a wheat starch.

The starch is fed into the reactor through a feeder.

The present invention has the following advantages over the prior art:

(1) in the process, a dry reaction of starch powders in a fluidized state is achieved by using active groups (including the high energy electrons and free radicals) and thermal effects thereof produced by the atmospheric pressure low-temperature dielectric barrier discharge plasma, which changes the structure of starch and further degrades the molecular weight of starch; and

(2) the method has such characteristics as recyclable treatment, large processing capacity, and superior reaction uniformity, and is also convenient, fast, energy-saving and environmentally friendly, and the process of the present invention is simple and cost-effective, and is also capable of efficiently and quickly degrading the molecular weight of starch, e.g., by 1-3 order(s) of magnitude within a short time. Moreover, the product has a superior transparency, retrogradation stability, and a certain thickening effect.

### DETAILED DESCRIPTION OF THE EXAMPLES

The present invention will be further described in detail below in conjunction with examples, but this does not limit the implementation of the present invention.

### Example 1

300 g of potato starch with 5% water content was added into an atmospheric pressure low-temperature dielectric barrier discharge plasma reactor through a screw feeder; the discharge gap was regulated to 0.2 mm at atmospheric pressure, the input voltage was 50 V, and the current was 1.0 A; the retention time of the materials in a fluidized state in the circulating system was controlled by regulating the air flow rate; and a series of starch-based food thickeners with low molecular weight were obtained after subjecting same to plasma discharge treatment for different time.

The potato starch and the starch-based food thickeners with low viscosity obtained by means of plasma discharge treatment for different time were gelatinized and then cooled to room temperature, and tested for viscosity. Table 1 shows the molecular weight of the obtained starch-based food thickeners with low viscosity and the viscosity obtained by a test using CC25 rotor at a shear rate of 600 s⁻¹. As can be seen from Table 1, the molecular weight of the potato starch decreased dramatically and the viscosity of the starch paste decreased markedly with the extension of treatment time, showing the characteristics of low viscosity with high solids content.

TABLE 1
Effects on molecular weight and viscosity of potato starch
with different plasma treatment time

| | Concentration (%) | | | | | | |
|---|---|---|---|---|---|---|---|
| | 6 | 6 | 6 | 12 | 12 | 12 | 12 |
| Plasma | 0 | 0.5 | 1 | 1 | 2 | 2.5 | 3 |
| treat- | | | | | | | |
| ment | | | | | | | |
| time | | | | | | | |
| (min) | | | | | | | |
| Molecu- | 4.912 × | 1.617 × | 1.412 × | 1.412 × | 1.194 × | 5.655 × | 1.159 × |
| lar | 10⁷ | 10⁷ | 10⁵ | 10⁵ | 10⁵ | 10⁴ | 10⁴ |
| weight | | | | | | | |
| (g/mol) | | | | | | | |
| Appar- | 978 | 830 | 321 | 1586 | 665 | 355 | 95 |
| ent | | | | | | | |
| vis- | | | | | | | |
| cosity | | | | | | | |
| (mPas) | | | | | | | |

### Example 2

The corn starch was adjusted with distilled water to a starch sample with 10% water content; 500 g of the starch sample was added into an atmospheric pressure low-temperature dielectric barrier discharge plasma reactor through a screw feeder; the discharge gap was regulated to 0.3 mm at atmospheric pressure, the input voltage was 30 V, and the current was 1.0 A; the retention time of the materials in a fluidized state in the circulating system was controlled at 0.5 min by regulating the air flow rate; and the product was taken out, i.e., to obtain a starch-based food thickener with low molecular weight of 3.115×10⁶ g/mol which decreased from the original molecular weight of 1.983×10⁷ g/mol.

The corn starch and the prepared starch-based thickeners with low molecular weight were dissolved in water, respectively, formulated as a concentration of 6% (w/w), cooled to room temperature after gelatinization, and then tested for viscosity. The results showed that after the plasma treatment, the starch viscosity reduced from 149 mPas to 107 mPas (at a shear rate of 600 s⁻¹, CC25 rotor).

### Example 3

The tapioca starch was adjusted with distilled water to a starch sample with 15% water content; 400 g of the starch sample was added into an atmospheric pressure low-temperature dielectric barrier discharge plasma reactor through a screw feeder; the discharge gap was regulated to 0.25 mm at atmospheric pressure, the input voltage was 70 V, and the current was 2.4 A; the retention time of the materials in a fluidized state in the circulating system was controlled at 30 min by regulating the air flow rate; and the product was taken out, i.e., to obtain a starch-based food thickener with low viscosity, with molecular weight of 2.314×10⁴ g/mol which decreased from the original molecular weight of 1.156×10⁷ g/mol.

The tapioca starch was gelatinized at a concentration of 6% (w/w), cooled to room temperature, and then tested for viscosity, which was 700 mPas; after the plasma treatment, the viscosity of the starch thickeners reduced greatly, and the viscosity was only 11 mPas at a concentration of 18% (at a shear rate of 600 s⁻¹, CC25 rotor).

### Example 4

The corn starch was adjusted with distilled water to a starch sample with 25% water content; 500 g of the starch sample was added into an atmospheric pressure low-temperature dielectric barrier discharge plasma reactor through a screw feeder; the discharge gap was regulated to 0.8 mm at atmospheric pressure, the input voltage was 50 V, and the current was 1.0 A; the retention time of the materials in a fluidized state in the circulating system was controlled at 1 min by regulating the air flow rate; and the product was taken out, i.e., to obtain a starch-based food thickener with low viscosity, with molecular weight of 6.105×10⁵ g/mol which decreased from the original molecular weight of 1.983×10⁷ g/mol.

The corn starch and the obtained starch-based food thickener with low molecular weight were formulated as 1% (w/w) starch slurry, respectively, gelatinized for 30 min in a boiling water bath, and cooled to room temperature (25° C.). According to the test, the absorbance of the corn starch was 0.952 at wavelength of 620 nm using distilled water as reference, and the absorbance of the starch-based food thickener with low molecular weight reduced to 0.648, indicating an increase in the transparency of the obtained starch-based food thickener with low molecular weight.

### Example 5

The tapioca starch was adjusted with distilled water to a starch sample with 30% water content; 600 g of the starch sample was added into an atmospheric pressure low-temperature dielectric barrier discharge plasma reactor through a screw feeder; the discharge gap was regulated to 0.2 mm at atmospheric pressure, the input voltage was 70 V, and the current was 0.2 A; the retention time of the materials in a fluidized state in the circulating system was controlled at 5 min by regulating the air flow rate; and the product was taken out, i.e., to obtain a starch-based food thickener with low viscosity, with molecular weight of 1.708×10⁵ g/mol which decreased from the original molecular weight of 1.156×10⁷ g/mol.

The tapioca starch and the obtained starch-based food thickener with low molecular weight were formulated as 1% (w/w) starch slurry, respectively, gelatinized for 15 min in a boiling water bath, and cooled to room temperature (25° C.), 50 mL of starch slurry was transferred into a 50 mL of measuring cylinder, respectively, and the volume of the supernatant was recorded at a set interval. According to the test, the volume of the supernatant of the tapioca starch increased by 1 mL every other hour in the first four hours, and for the starch-based food thickener with low molecular weight, there was basically no water precipitated within the 4 hours, indicating that the starch-based food thickener with low molecular weight obtained an obvious retrogradation stability compared to the original starch.

### Example 6

The potato starch was adjusted with distilled water to a starch sample with 15% water content; 400 g of the starch sample was uniformly dispersed in an atmospheric pressure low-temperature dielectric barrier discharge plasma reactor; the discharge gap was regulated to 0.3 mm at atmospheric pressure, the input voltage was 50 V, and the current was 1.5 A; the retention time of the materials in a fluidized state in the circulating system was controlled at 3 min by regulating the air flow rate; and the product was taken out, i.e., to obtain a starch-based food thickener with low viscosity, with molecular weight of 6.127×10⁵ g/mol which decreased from the original molecular weight of 4.912×10⁷ g/mol.

The starch-based food thickener with low viscosity, in which the amount was 1% of the mass of corn starch (dry basis) was added into the corn starch slurry with a concentration of 6% (w/w), gelatinized and then cooled to room temperature, and tested for viscosity. The results showed that the starch slurry viscosity could be increased from 284 mPas to 400 mPas (at a shear rate of 100 s⁻¹, CC45 rotor), indicating a good thickening effect of the modified starch.

The above Examples are preferred implementations of the present invention. However, the implementation of the present invention is not limited by the above Examples, and any alternation, modification, substitution, combination and simplification without departing from the spiritual essence and principles of the present invention should all be equivalent replacement methods, and all fall within the scope of protection of the present invention.

1. A preparation method of a starch-based food thickener with low molecular weight, characterized by comprising the steps of:
adding starch powders with 5%-30% moisture content into an atmospheric pressure low-temperature dielectric barrier discharge plasma reactor, regulating the discharge gap to 0.2 mm-0.8 mm at atmospheric pressure, the discharge input voltage to 30 V-70 V, and the discharge current to 0.2 A-2.4 A, subjecting the materials in a fluidized state to plasma action in the circulating system by regulating the air flow rate with controlling time longer than 0.5 min, and then taking out the product after the completion of the reaction, i.e., to obtain a starch-based food thickener with low molecular weight.

2. The preparation method according to claim 1, characterized in that the time is controlled between 0.5 min-30 min.

3. The preparation method according to claim 2, characterized in that the starch is one of or a mixture comprising two or more of a corn starch, a tapioca starch, a potato starch, a high amylose corn starch, an indica rice starch, a japonica starch, a sweet potato starch, a waxy corn starch and a wheat starch.

4. The preparation method according to claim 1, characterized in that the starch is fed into the reactor through a feeder.

5. A starch-based food thickener with low molecular weight prepared by the method according to claim 1.

6. The preparation method according to claim 2, characterized in that the starch is fed into the reactor through a feeder.

7. The preparation method according to claim 3, characterized in that the starch is fed into the reactor through a feeder.

8. A starch-based food thickener with low molecular weight prepared by the method according to claim 2.

9. A starch-based food thickener with low molecular weight prepared by the method according to claim 3.

10. A starch-based food thickener with low molecular weight prepared by the method according to claim 4.

11. A starch-based food thickener with low molecular weight prepared by the method according to claim 6.

12. A starch-based food thickener with low molecular weight prepared by the method according to claim 7.
